(19) United States
(12) Patent Application Publication
(10) Pub. No.: US 2010/0090079 A1
(43) Pub. Date: Apr. 15, 2010

(54) CUPHOLDER FOR AN AUTOMOBILE

(75) Inventor: Ki Hwan Choi, Cheonan-si (KR)

Correspondence Address: KIRTON AND MCCONKIE, 60 EAST SOUTH TEMPLE,, SUITE 1800, SALT LAKE CITY, UT, 84111, US

(73) Assignee: NIFCO KOREA INC., Cheonan-si (KR)

(21) Appl. No.: 12/519,613

(22) PCT Filed: Dec. 27, 2007
(86) PCT No.: PCT/KR2007/006884

§ 371 Date: Jun. 17, 2009

(30) Foreign Application Priority Data
Jan. 2, 2007 (KR) 10-2007-0000160

(51) Int. Cl. B60N 3/10

(52) U.S. Cl. 248/311.2

(57) ABSTRACT

The present invention relates to a cupholder for an automobile, in which a beverage container may be inserted regardless of the size or shape thereof by a pair of springs (140) and a supporting element rotating (130) upward or downward, and from which such a received beverage container may be smoothly separated without any interference or holding.

### TECHNICAL FIELD

The present invention relates to a cupholder for an automobile, in which insertion and withdrawal of a beverage container may be achieved smoothly without any interference or holding regardless of the size or shape of the beverage container by a pair of springs and supporting elements rotating upward or downward.

### BACKGROUND ART

In general, a cupholder for an automobile may be mounted to a center facia panel mounted with manipulation panels for an audio system and an air conditioner, wherein the cupholder slides to be inserted into the center facia panel or withdrawn therefrom. Also, the cupholder may be exposed to a floor console tray between a gear shift lever and a console box.

The cupholder is usually formed with an inlet part in a predetermined size. Recently, there is a trend to adopt a structure for receiving any beverage container regardless of a diameter thereof. Further, the cupholder is in the structure for stably supporting an outer diameter surface of such a beverage container to prevent the beverage container from shaking due to the vibration or swaying of an automobile.

Referring to FIG. 1, a cupholder for inserting a beverage container regardless of the diameter thereof includes a housing defined with a cup receiving part and formed with supporting element receiving parts. A supporting element is mounted in each of the supporting element receiving parts, wherein the supporting element is inserted inward by compression of a spring and withdrawn outward to the outside of the inlet part by elastic restoring force of the spring.

In other words, the supporting element is in the state to be protruded in the inlet part by the elastic force of the spring all the time, and pushed in the supporting element receiving part by a beverage container as the beverage container is inserted into the inlet part. The supporting element compresses the spring and pushed in the inlet part in response to the insertion of the beverage container, and supports a peripheral surface of the beverage container in close contact as the beverage container is secured in the inlet.

### DISCLOSURE OF INVENTION

### Technical Problem

The prior art cupholder for an automobile as described hereinabove has, however, disadvantages as follows.

First, if the beverage container to be inserted into the inlet part of the cupholder is in the shape with a middle part curved concave such as a coke bottle or a wide lower end having a large diameter such as a beer can, which has a folded part protruded at a lower end, then a front end of the supporting element is held in the concave or folded portion of such the beverage container when the beverage container is withdrawn from the cupholder. Conclusionally, the beverage container cannot be separated from the cupholder smoothly.

Second, the supporting element contacts and supports a beverage container at a different supporting point according to the size of the beverage container, so that the supporting element contacts a beverage container having a large diameter at a lower part of the beverage container and the beverage container may be fallen down out of the cupholder, polluting an inside of the automobile by the contents spilt from the beverage container.

Therefore, a cupholder for an automobile, which is easy and stable both in the insertion and withdrawal, has been demanded.

### Technical Solution

The present invention is derived to resolve the above and any other disadvantages of the prior art, and an object of the invention is to provide a cupholder for an automobile for inserting a beverage container regardless of the size or shape thereof, wherein a supporting element moves downward when inserting the beverage container for stably holding a peripheral surface of the beverage container by tension of a dual distortion spring, and the supporting element moves upward together with the beverage container when withdrawing the beverage container for separating the beverage container smoothly from the cupholder for an automobile without any interruption or interference of the supporting element even though a lower end of the beverage container is wide.

In order to achieve the above object, according to the present invention, there is provided an improved cupholder for an automobile including a cupholder housing defined with a cup receiving part, supporting parts mounted outside the cup receiving part and having supporting elements moving in and out of the cup receiving part and rotating with respect to first pins, and distortion springs mounted between the supporting parts and the supporting elements for inserting the supporting parts withdrawn to the outside of the cup receiving part into the inside of the cup receiving part by its inherent elasticity to hold a beverage container in the cup receiving part, the improvement comprising:

second pins protruded from lower parts of the supporting elements where the first pins are protruded; and

first guide grooves and second guide grooves formed at upper and lower parts of the supporting parts respectively, so that the first pins and the second pins slidingly move downward along the first guide grooves and the second guide grooves according to an outer diameter and the shape of the beverage container which is inserted into or withdrawn from the cup receiving part and simultaneously guided in a direction along the first guide grooves and the second guide grooves;

wherein the distortion springs mounted between the supporting parts and the supporting elements are dual distortion springs having tension at both sides respectively.

The distortion spring has an end fixed to the supporting part and the other end fixed to the supporting element which comes in or out from the cup receiving part.

### BRIEF DESCRIPTION OF THE DRAWINGS

The objects, features and advantages of the present invention will be more clearly understood from the following detailed description in conjunction with the accompanying drawings, in which:

FIG. 1 is a perspective view showing a prior art cupholder for an automobile.

FIG. 2 is a perspective view showing a cupholder for an automobile according to a preferred embodiment of the present invention.

FIG. 3 is a perspective view showing a dual distortion spring for the cupholder for an automobile according to the present invention.

FIG. 4 is an expanded view showing principal parts of the cupholder for an automobile according to the present invention.

FIG. 5 is an expanded view showing a state for inserting a beverage container having a large outer diameter into the cup receiving part of the cupholder for an automobile according to the present invention.

FIG. 6 is an expanded view showing a state that the beverage container having a large outer diameter is completely inserted into the cup receiving part of the cupholder for an automobile according to the present invention.

FIG. 7 is an expanded view showing a state for withdrawing the beverage container having a large outer diameter from the cup receiving part of the cupholder for an automobile according to the present invention.

FIG. 8 is an expanded view showing a state that a beverage container having a small outer diameter is completely inserted into the cup receiving part of the cupholder for an automobile according to the present invention, and

FIG. 9 is an expanded view showing a state for withdrawing the beverage container having the small outer diameter from the cup receiving part of the cupholder for an automobile according to the present invention.

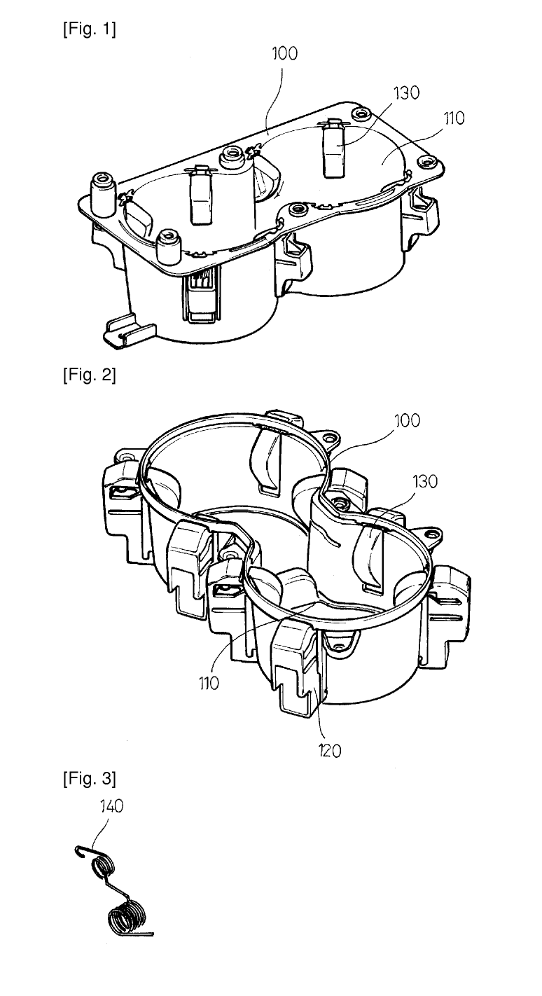

### MODE FOR THE INVENTION

Now, a cupholder for an automobile according to the present invention will be described in more detail in the structure and operation thereof with reference to the accompanied drawings.

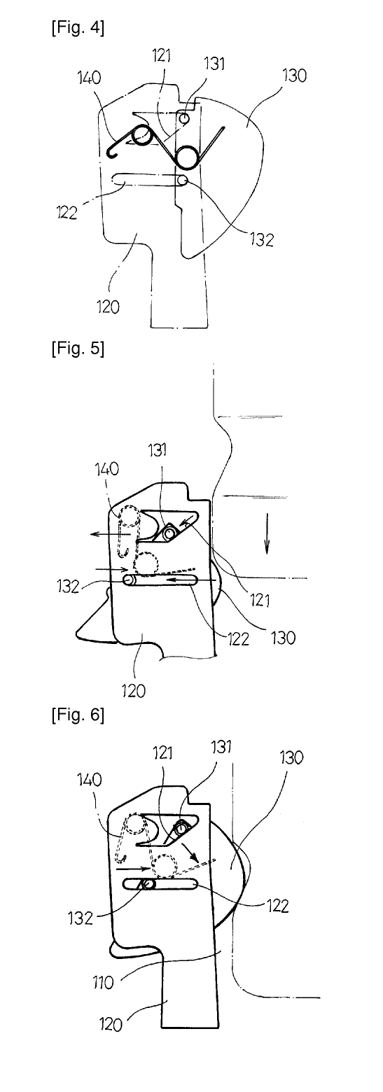

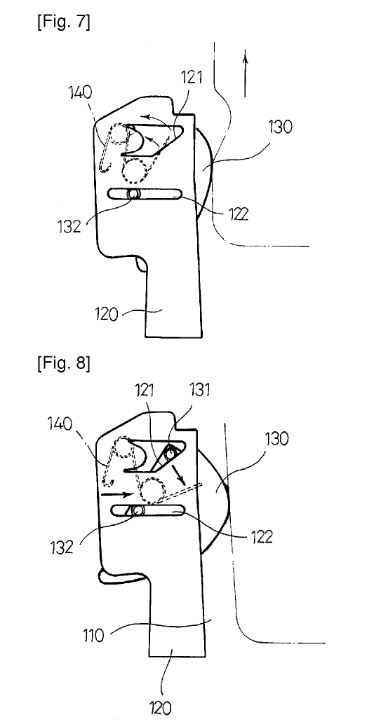

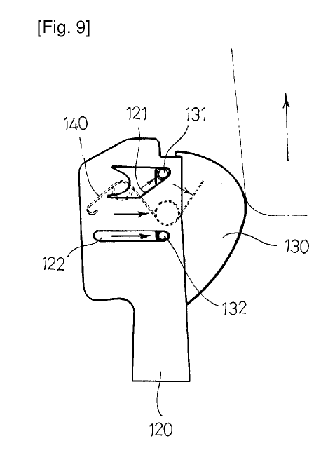

FIG. 2 is a perspective view showing an appearance of a cupholder for an automobile according to a preferred embodiment of the present invention, FIG. 3 is a perspective view showing a dual distortion spring for the cupholder for an automobile according to the present invention, FIG. 4 is an expanded view showing principal parts of the cupholder for an automobile according to the present invention, FIG. 5 is an expanded view showing a state for inserting a beverage container having a large outer diameter into a cup receiving part of the cupholder for an automobile according to the present invention, FIG. 6 is an expanded view showing a state that the beverage container having a large outer diameter is completely inserted into the cup receiving part of the cupholder for an automobile according to the present invention, FIG. 7 is an expanded view showing a state for withdrawing the beverage container having a large outer diameter from the cup receiving part of the cupholder for an automobile according to the present invention, FIG. 8 is an expanded view showing a state that a beverage container having a small outer diameter is completely inserted into the cup receiving part of the cupholder for an automobile according to the present invention, and FIG. 9 is an expanded view showing a state for withdrawing the beverage container having the small outer diameter from the cup receiving part of the cupholder for an automobile according to the present invention.

Referring to FIG. 2, the cupholder for an automobile according to the present invention includes, a cupholder housing 100 defined with a cup receiving part 110 inside, and mounted with supporting parts 120 outside. The supporting parts 120 are respectively formed with first guide grooves 121 and second guide grooves 122 at upper and lower parts thereof, so that first pins 131 and second pins 132, which are respectively mounted at upper and lower parts of supporting elements 130, are respectively inserted into the first guide grooves 121 and the second guide grooves 122.

Dual distortion springs 140 having tension are mounted at both right and left sides in the supporting elements 130, of which the first pins 131 and the second pins 132 are inserted into the first guide grooves 121 and the second guide grooves 122, wherein an end of each of the dual distortion springs is fixed to the supporting element 130 and the other end is fixed to the supporting part 120.

The first guide groove 121 formed at the upper part of the supporting part is inclined in a direction and the second guide groove 122 formed at the lower part of the supporting part 120 is horizontal in the traverse direction, so that a movement amount of a supporting point may be minimized even when an outer diameter of a beverage container 200 to be inserted into the cup receiving part 110 is large and the beverage container 200 may be supported as being inserted into the cup receiving part 110.

The operations of the cupholder for an automobile according to the present invention structured as above will be described in more detail hereinafter.

FIG. 4 to FIG. 9 are sectional views respectively showing operation states of the cupholder for an automobile according to the present invention.

As shown in FIG. 4, the supporting element 130 for the cupholder for an automobile of the present invention is kept in the state protruded in the cupholder by the tension of the dual distortion spring 140 when the beverage container 200 is not inserted and kept in the cup receiving part 110, wherein the dual distortion spring 140 exhibits no distortion.

As shown in FIG. 5, if a beverage container 200 having a large outer diameter is inserted into the cup receiving part 110, the first pin 131 mounted in the supporting element 130 is guided downward along the first guide groove, which is formed with an inclination, and simultaneously the second pin 132 is guided to the outside of the cup receiving part 110 along the second guide groove 122.

In the state, an outer surface of the supporting element 130 is supported by the tension of a distortion spring part of the dual distortion spring 140 and kept in contact with an outer surface of the beverage container 200.

As the beverage container 200 is finally inserted into the cup receiving part 110 in contact with the outer surface of the supporting element 130 as above described, the supporting element 130 is inserted inward by the tension of the dual distortion spring 140, as shown in FIG. 6, and supports an outer surface of the beverage container 200 in close contact at the outer end of the supporting element 130.

When withdrawing a beverage container 200 such as a coke bottle of which a lower end part is wide and a middle part is curved concave or a beer can of which a lower end is formed with a folded end in the shape of protrusion out of the cup receiving part 110, as shown in FIG. 7, the first pin 131 and the second pin 132 of a supporting element 130 respectively move upward and toward the center of the cup receiving part 110 by the dual distortion spring 140 as much as an upper movement amount of the beverage container 200. Then, the supporting element 130 moves upward and simultaneously in a direction by the movement amount of the first pin 131 and the second pin 132, so that the beverage container 200 may be smoothly withdrawn without any interference of the supporting element 130 even though the lower end part of the beverage container 200 is wide.

At this time, the supporting element 130 is restored to an initial position thereof always by the tension of the dual distortion spring 140.

Further, if the beverage container 200 supported by the supporting element 130 is in the straight shape in the vertical direction, as shown in FIG. 8 and FIG. 9, the beverage container 200 may be naturally inserted into or withdrawn from the cup receiving part 110 by simply holding the beverage container 200 and applying pressure to the beverage container 200 downward or upward.

In other words, the beverage container 200 may be simply separated from the cup receiving part 110 without any interference from the supporting element 130 since the beverage container 200 has the straight surface in the vertical direction.

As described hereinabove, according to the cupholder for an automobile of the present invention, the supporting element rotates downward and simultaneously moves outward from the cup receiving part for stably holding the outer surface of the beverage container by the tension of the dual distortion spring when inserting the beverage container in the cup receiving part. When withdrawing the beverage container, especially having the holding protrusion portion or the folded portion at the lower end part, from the cup receiving part, the supporting element rotates upward together with the beverage container for smoothly separating the beverage container from the cup receiving part without any interference from the supporting element.

That is, the cupholder for an automobile according to the present invention may provide smooth and natural withdrawal operation without any interference from the supporting element, which supports the beverage container.

Although the foregoing description has been made with reference to the preferred embodiments, it is to be understood that changes and modifications of the present invention may be made by the ordinary skilled in the art without departing from the spirit and scope of the present invention and appended claims.

1. A cupholder for an automobile including a cupholder housing defined with a cup receiving part, supporting parts mounted outside the cup receiving part and having supporting elements moving in and out of the cup receiving part and rotating with respect to first pins, and distortion springs mounted between the supporting parts and the supporting elements for inserting the supporting parts withdrawn to the outside of the cup receiving part into the inside of the cup receiving part by inherent elasticity to hold a beverage container in the cup receiving part,
characterized in that second pins are protruded from lower parts of the supporting elements where the first pins are protruded;
first guide grooves and second guide grooves are formed at upper and lower parts of the supporting parts respectively, so that the first pins and the second pins move according to the beverage container which is inserted into or withdrawn from the cup receiving part; and
the distortion springs mounted between the supporting parts and the supporting elements are dual distortion springs having tension at both sides respectively.

2. The cupholder for an automobile as claimed in claim 1, wherein the first guide grooves formed at the upper parts of the supporting parts are formed with inclination in a direction and the second guide grooves formed at the lower parts of the supporting parts are formed horizontally in the traverse direction.
